(19) United States
(12) Patent Application Publication
(10) Pub. No.: US 2025/0270855 A1
(43) Pub. Date: Aug. 28, 2025

(54) U-LOCK STRUCTURE

(71) Applicant: Cheng-Yu TSAI, HEMEI TOWNSHIP (TW)

(72) Inventor: Cheng-Yu TSAI, HEMEI TOWNSHIP (TW)

(21) Appl. No.: 18/612,326

(22) Filed: Mar. 21, 2024

(30) Foreign Application Priority Data
Feb. 23, 2024 (TW) 113201859

(51) Int. Cl. E05B 67/06

(52) U.S. Cl. CPC E05B 67/063

(57) ABSTRACT

A U-lock structure comprising a lock body, a U-lock rod, and two end caps, wherein the U-lock rod is inserted into the lock body and the two end caps are fitted onto the left and right ends of the lock body, respectively. The lock body includes a lock seat fitted within a sleeve assembly, a lock core installed at one end of the lock seat and connected to the lock seat via an actuating member, the lock core having a keyhole for inserting a key, whereby rotation of the lock core causes the lock seat to rotate back and forth to form a locked or unlocked state. Wherein the two end caps are used to seal the left and right ends of the sleeve assembly, preventing dust or particles from entering the sleeve assembly or the lock seat, thereby avoiding situations where locking or unlocking cannot be performed.

### FIELD OF INVENTION

The present disclosure relates to locks, in particular to a U-lock structure with a simple structure capable of preventing dust and particles from the environment from entering the interior of the lock.

### BACKGROUND OF THE PRESENT DISCLOSURE

Conventional U-locks, as exemplified by those described in Taiwanese Invention Patent No. TWI667402B, consist of components such as a lock body, a lock core, a push rod, a brake member, an inner sleeve, an outer shell, and a U-lock rod. The U-lock rod has an engagement groove at each insertion head. When the key is turned, the lock core is rotated and pushes the push rod to engage the brake member in the engagement groove, completing the locking action by securing the brake member in the engagement groove. Unlocking is accomplished by turning the key in the opposite direction to stop the lock core from pushing the push rod, allowing the U-lock rod to exit the engagement groove to complete the unlocking process.

However, the disadvantage of the aforementioned disclosed U-lock design lies in its complicated structure, low manufacturing efficiency, and susceptibility to infiltration of environmental dust and particles due to the open configuration at both ends of the lock body. This vulnerability leads to potential malfunctions when internal components such as the lock core, push rod, or brake member are blocked by the dust, rendering the U-lock unable to perform locking or unlocking operations.

### SUMMARY OF THE PRESENT DISCLOSURE

Based on the above shortcomings, the purpose of the present disclosure is to provide a U-lock, in particular one having a simple structure capable of preventing dust or particles from entering the interior of the lock.

According to the purpose of the present disclosure, a U-lock structure is provided including a lock body, a U-lock rod, and two end caps. The lock body has a lock seat fitted in a sleeve assembly, and the lock seat is rotated together with a lock core. The sidewall of the lock seat includes two insertion ports spaced from each other, and the lock seat defines a width in an axial direction, wherein each insertion port includes a first slot and a second slot connected along the rotational direction of the lock body, and the width of the first slot is greater than the width of the second slot. The U-lock rod has two insertion heads inserted into the two insertion ports. The two end caps are fitted onto both ends of the lock body, respectively, with one of the end caps having an insertion hole for inserting a key.

Wherein, the lock core is installed at one end of the lock seat, and the lock seat is connected to the lock core via an actuating member.

Wherein, a sealing seat is further provided at the other end of the lock seat, with a connecting rod connecting the sealing seat to the sleeve assembly.

Wherein, the sleeve assembly comprises a first sleeve and a second sleeve fitted inside the first sleeve, and the lock seat is fitted inside the second sleeve. Both the first sleeve and the second sleeve each have two through-holes corresponding to the two insertion ports.

Wherein, the first sleeve comprises a straight tube body and two outer tube bodies.

Wherein, one end of the first sleeve is provided with an opening that communicates with the insertion hole of the end cap and a keyhole of the lock core.

Wherein, the two insertion heads of the U-lock rod each include a first positioning section, a second positioning section, a protrusion, and a third positioning section formed sequentially from top to bottom.

Wherein, the sidewall of the lock seat also features two slots corresponding to the two insertion ports.

Wherein, the second sleeve also features two perforations corresponding to the two slots.

### BRIEF DESCRIPTION OF THE DRAWINGS

FIG. 1 is a schematic diagram of an embodiment of the present disclosure.

FIG. 2 is an exploded view of components of an embodiment of the present disclosure.

FIG. 3 is a sectional view taken along line 3-3 of FIG. 1.

FIG. 4 is a schematic diagram of a second sleeve of an embodiment of the present disclosure.

FIG. 5 is a perspective view of a lock core seat of an embodiment of the present disclosure.

FIG. 6 is another perspective view of the lock core seat of an embodiment of the present disclosure.

FIG. 7 is an enlarged view of an insertion head of an embodiment of the present disclosure.

FIG. 8 is a schematic diagram of the locked state of an embodiment of the present disclosure.

FIG. 9 is a schematic diagram of the unlocked state of an embodiment of the present disclosure.

### DETAILED DESCRIPTION OF THE PREFERRED EMBODIMENTS

In order to clearly illustrate the specific embodiments, structures and effects achieved by the present disclosure, the following embodiments are provided with reference to the drawings:

Directional descriptions such as “front,” “rear,” “top,” “bottom,” “left,” and “right” mentioned herein are for ease of understanding. The present disclosure is not limited to these directions, but may be adjusted according to actual circumstances. The direction of insertion of a U-lock rod 50 of the present disclosure into a lock body 100 is considered to be a vertical direction, an axial direction of the lock body 100 is considered to be a horizontal direction, and the direction of rotation of a key 60 is considered to be a forward-backward direction.

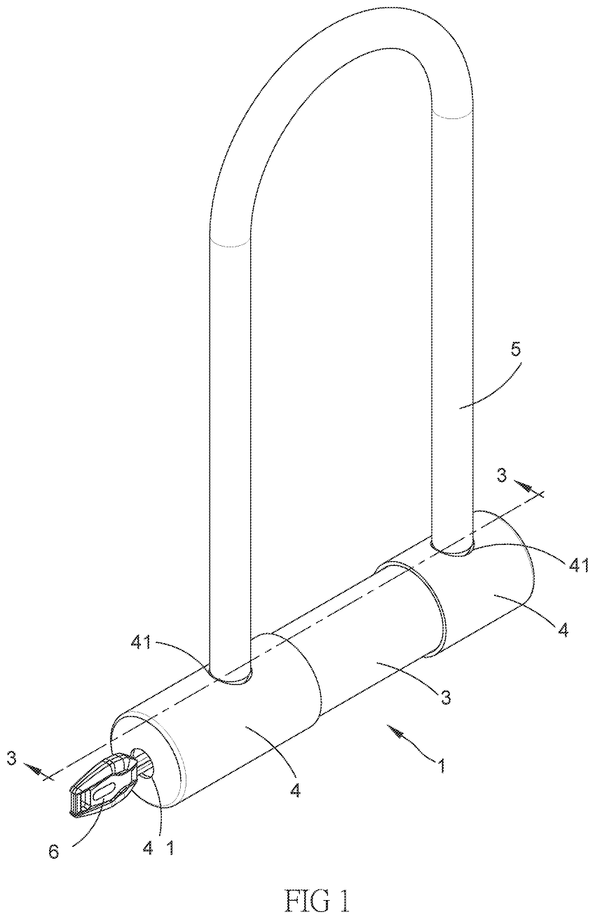

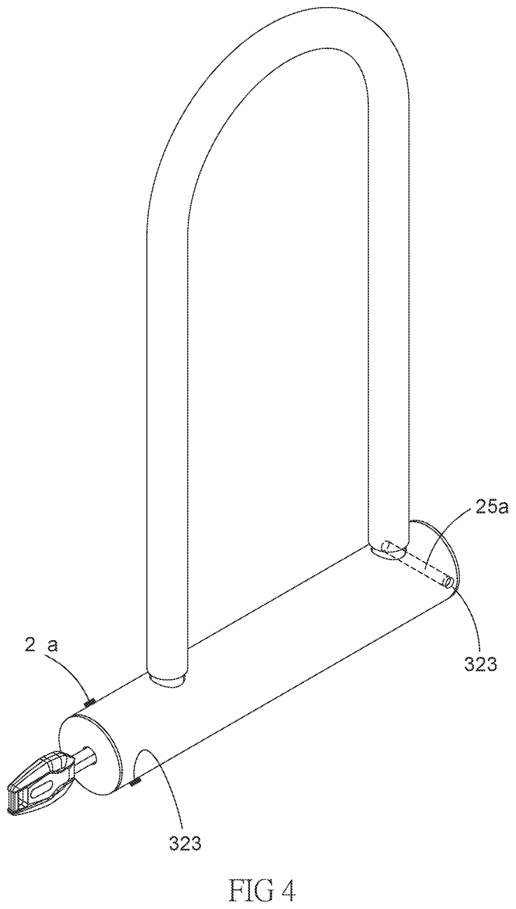

Reference is made to FIGS. 1 to 7, which illustrate a U-lock structure comprising the lock body 100, the U-lock rod 50, and two end caps 40. The U-lock rod 50 is inserted into the lock body 100, and the two end caps 40 are fitted onto the left and right ends of the lock body 100, respectively.

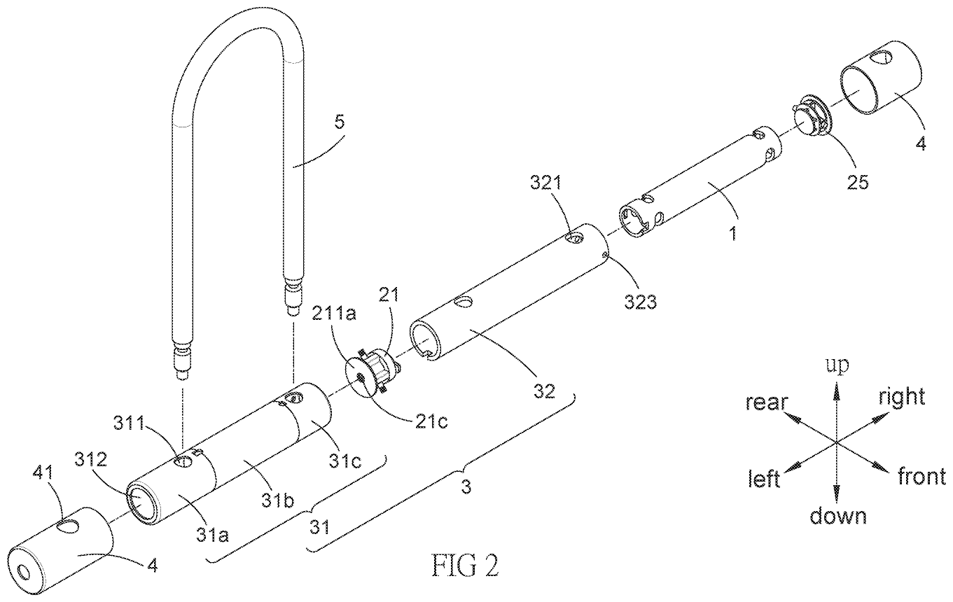

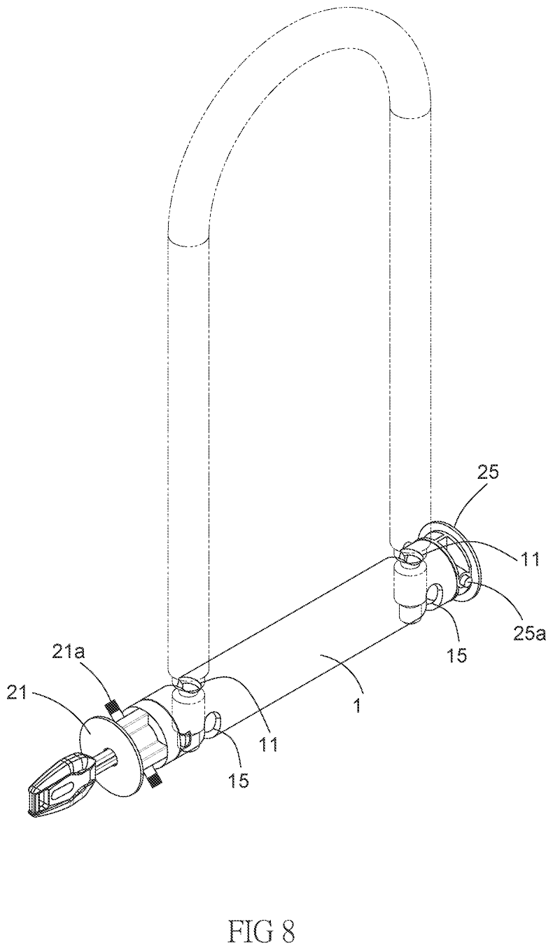

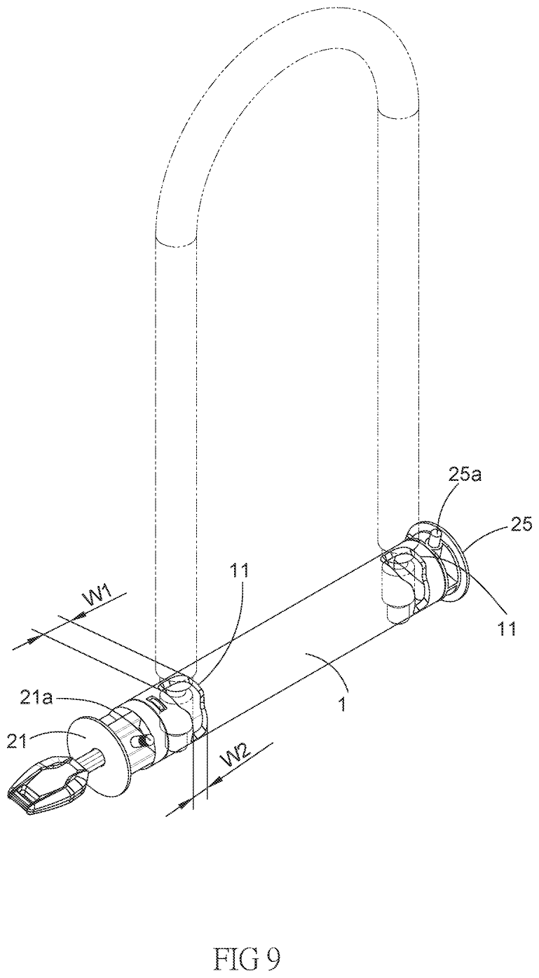

Further referring to FIGS. 2 to 4, the lock body 100 has a lock seat 10 fitted in a sleeve assembly 30, and a lock core 21 is installed at one end of the lock seat 10. The lock core 21 includes a lock core seat 211 and a rotary shaft 212 inserted into the lock core seat 211, and the rotary shaft 212 has a protrusion protruding from the lock core seat 211. Wherein the lock core seat 211 is disposed at one end of the lock seat 10 and connected to the sleeve assembly 30 via a connecting rod 21a, and the protrusion is connected to the lock seat 10 via an actuating member 22. The lock core seat 211 has a keyhole 21c for inserting a key 60 to rotate the rotary shaft 212. When the rotary shaft 212 is rotated, it drives the lock seat 10 to rotate back and forth, thereby forming a locked state (as shown in FIG. 8) or an unlocked state (as shown in FIG. 9). The other end of the lock seat 10 is provided with a sealing seat 25 connected to the sleeve assembly 30 by a connecting rod 25a.

In the embodiment of the present disclosure, the sleeve assembly 30 comprises a first sleeve 31 and a second sleeve 32 fitted inside the first sleeve 31, and the lock seat 10 is fitted inside the second sleeve 32. The connecting rod 21a of the lock core seat 211 and the connecting rod 25a of the sealing seat 25 are inserted into positioning holes 323 on the sidewall of the second sleeve 32, respectively, to fix the lock core seat 211 and the sealing seat 25. More specifically, the lock core seat 211 further includes a bottom cover 211a for sealing one end of the second sleeve 32, while the sealing seat 25 seals the other end, and the keyhole 21c for inserting the key 60 is formed on the bottom cover 211a. In the embodiment of the present disclosure, the first sleeve 31 comprises a straight tube body 31b and two outer tube bodies 31a, 31c, which may be one integral component or two separate components.

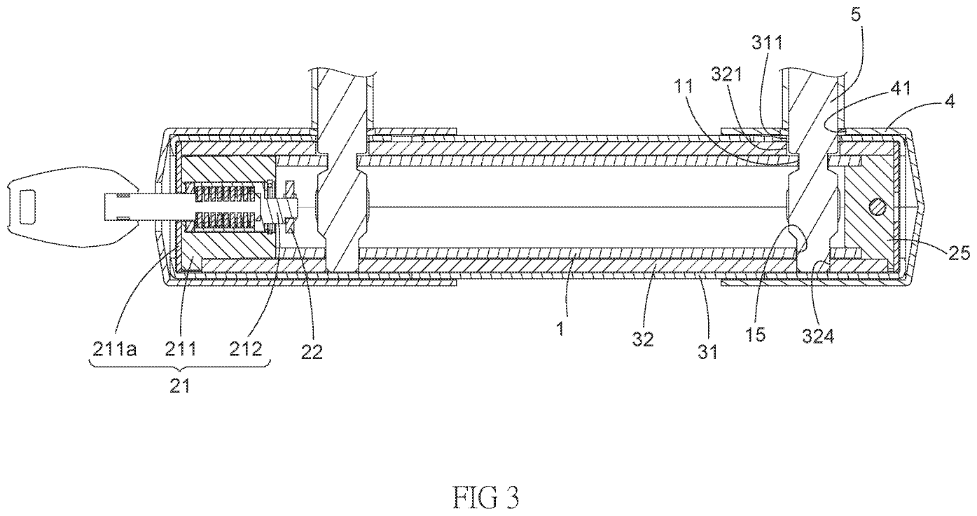

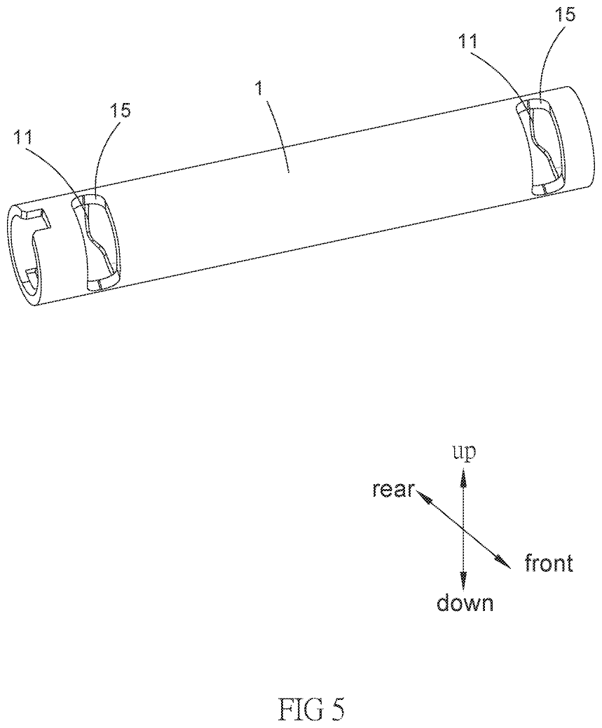

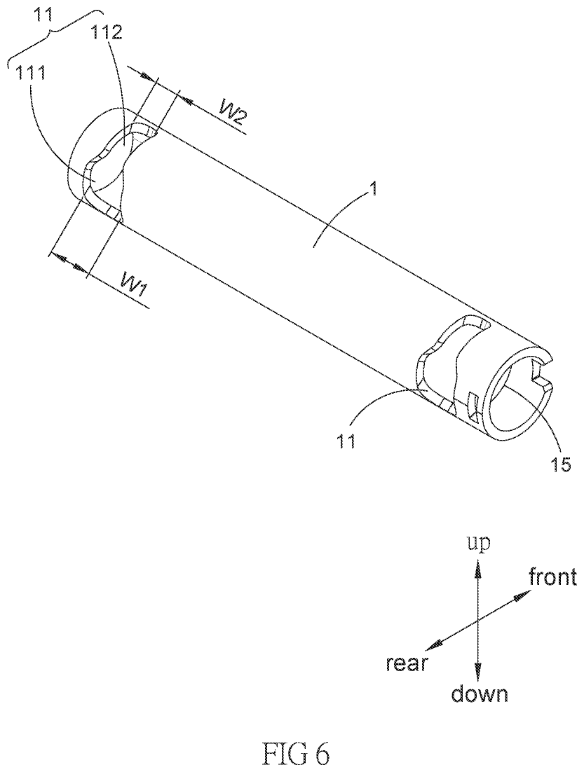

With further reference to FIGS. 5 and 6. The sidewall of the lock seat 10 includes two insertion ports 11 spaced from each other, and the two insertion ports 11 are for inserting insertion heads 50a of the U-lock rod 50. In the axial direction, the lock seat 10 defines a width, and each insertion port 11 includes a first slot 111 and a second slot 112 connected along the rotational direction of the lock body 100, where the width W1 of the first slot 111 is greater than the width W2 of the second slot 112, making the outline of the insertion port 11 approximately T-shaped. In addition, the sidewall of the lock seat 10 features two slots 15 corresponding to the two insertion ports 11, and the sidewall of the second sleeve 32 features two perforations 324 corresponding to the two slots 15. When the insertion heads 50a are inserted into the lock seat 10, they simultaneously enter the two insertion ports 11, the two slots 15, and the two perforations 324 (as shown in FIG. 3).

Furthermore, by setting the first sleeve 31 to seal the positioning holes 323 and the perforations 324 on the sidewall of the second sleeve 32 to form a protective sleeve for these positioning holes 323, dust or particles from the air are thus prevented from entering the second sleeve 32. Both the sidewall of the first sleeve 31 and the sidewall of the second sleeve 32 each have two through-holes 311, 321 corresponding to the two insertion ports 11, allowing the insertion heads 50a of the U-lock rod 50 to be inserted into the two insertion ports 11. Wherein the two through-holes 311 of the first sleeve 31 are located on the two outer tube bodies 31a, 31c, respectively.

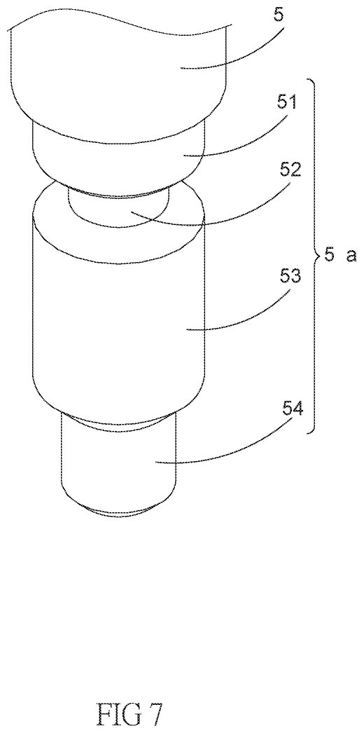

Referring to FIG. 7. The insertion heads 50a of the U-lock rod 50 each include a first positioning section 51, a second positioning section 52, a protrusion 53, and a third positioning section 54 formed sequentially from top to bottom. Wherein the protrusion 53 protrudes in a diameter direction relative to the second positioning section 52 and the third positioning section 54, while the second positioning section 52 forms an annular groove between the first positioning section 51 and the protrusion 53.

Referring to FIG. 8. When the user rotates the rotary shaft backward with the key 60, the lock seat 10 simultaneously rotates backward, causing the second positioning section 52 of each insertion head of the U-lock rod 50 to contact the wall of the second slot 112 to form the locked state. At this point, the protrusion 53 of each insertion head 50a of the U-lock rod 50 is within the lock seat 10, and the third positioning section 54 of the U-lock rod 50 is inserted into the slot 15 and the perforation 324, with the perforation 324 serving to reinforce the positioning of the U-lock rod 50 and limit the movement of the insertion head 50a.

Referring to FIG. 9. When the user rotates the rotary shaft forward with the key 60, the lock seat 10 simultaneously rotates forward until the second positioning section 52 of each insertion head of the U-lock rod 50 contacts the wall of the first slot 111 to form the unlocked state. At this point, the user can remove the insertion head 50a from the lock body 100.

In the embodiment of the present disclosure, the two end caps 40 are fitted onto the left and right ends of the lock body 100, respectively. The sidewall of each end cap 40 has a through-hole 41 for inserting the U-lock rod 50 into the lock body 100. One of the end caps 40 has a bottom wall with an insertion hole 401 for inserting the key 60. The two end caps 40 are used to seal the left and right ends of the sleeve assembly 30, leaving only the insertion hole 401 for the key 60 to prevent dust or particles from entering the interior of the sleeve assembly 30 or the lock seat 10, thereby preventing the situations where locking or unlocking cannot be performed. Wherein both ends of the first sleeve 31 are open ends, and one end of the first sleeve 31 is provided with an opening 312 that communicates with the insertion hole 401 of the end cap 40 and the keyhole 21c of the lock core 21, allowing the key 60 to be inserted into the lock core seat 211 to rotate the rotary shaft 212.

The present disclosure achieves the effect of limiting the movement of the U-lock rod 50 by a simple structure of providing the insertion ports 11 on the surface of the lock seat 10, which is not only user-friendly, but also more convenient for manufacturing and production. Furthermore, by providing the end caps 40, which can prevent dust or particles from entering the inside of the sleeve assembly 30 or the lock seat 10, the situations in which locking or unlocking cannot be performed can be avoided.

What is claimed is:

1. A U-lock structure, comprising:
a lock body having a lock seat fitted in a sleeve assembly, where the lock seat is rotated together with a lock core; the sidewall of the lock seat includes two insertion ports spaced from each other, and the lock seat defines a width in an axial direction; wherein each insertion port includes a first slot and a second slot connected along the rotational direction of the lock body, and the width of the first slot is greater than the width of the second slot;
a U-lock rod having two insertion heads inserted into the two insertion ports; and
two end caps respectively fitted onto both ends of the lock body, one of the end caps having an insertion hole for inserting a key.

2. The U-lock structure according to claim 1, wherein the lock core is installed at one end of the lock seat, and the lock seat is connected to the lock core via an actuating member.

3. The U-lock structure according to claim 2, wherein a sealing seat is further provided at the other end of the lock seat, with a connecting rod connecting the sealing seat to the sleeve assembly.

4. The U-lock structure according to claim 1, wherein the sleeve assembly comprises a first sleeve and a second sleeve fitted inside the first sleeve, the lock seat is fitted inside the second sleeve, and both the first sleeve and the second sleeve each have two through-holes corresponding to the two insertion ports.

5. The U-lock structure according to claim 4, wherein the first sleeve comprises a straight tube body and two outer tube bodies.

6. The U-lock structure according to claim 5, wherein one end of the first sleeve is provided with an opening that communicates with the insertion hole of the end cap and a keyhole of the lock core.

7. The U-lock structure according to claim 1, wherein the two insertion heads of the U-lock rod each include a first positioning section, a second positioning section, a protrusion, and a third positioning section formed sequentially from top to bottom.

8. The U-lock structure according to claim 5, wherein the sidewall of the lock seat further features two slots corresponding to the two insertion ports.

9. The U-lock structure according to claim 8, wherein the second sleeve further features two perforations corresponding to the two slots.
